(19) United States
(12) Patent Application Publication
(10) Pub. No.: US 2008/0102023 A1
(43) Pub. Date: May 1, 2008

(54) REFORMING APPARATUS FOR FUEL CELLS

(75) Inventors: Yoshinori Saito, Otsu-shi (JP); Yukio Sakabe, Kyoto-shi (JP)

Correspondence Address: OSTROLENK FABER GERB & SOFFEN, 1180 AVENUE OF THE AMERICAS, NEW YORK, NY, 100368403, US

(73) Assignee: Murata Manufacturing Co., Ltd.

(21) Appl. No.: 11/958,030

(22) Filed: Dec. 17, 2007

Related U.S. Application Data
(63) Continuation of application No. PCT/JP2006/308230, filed on Apr. 19, 2006.

(30) Foreign Application Priority Data
Jun. 24, 2005 (JP) 2005-185569
Sep. 15, 2005 (JP) 2005-269058

(51) Int. Cl. C01B 3/02; B01J 19/00

(52) U.S. Cl. 423/648.1; 422/129; 422/188

(57) ABSTRACT

A reforming apparatus for fuel cells capable of effectively removing carbon dioxide at a high temperature from a reformed gas which is produced by a steam reforming method, and of producing high-purity hydrogen gas with a high hydrogen conversion rate. A reforming apparatus for fuel cells includes a reformer for steam-reforming a raw material to produce hydrogen, and carbon dioxide removing apparatus for removing carbon dioxide gas by absorbing carbon dioxide from a reformed gas, which is produced by steam reforming in the reformer, using a material containing Ba₂TiO₄ as a main component as a carbon dioxide absorbent. The reforming apparatus for fuel cells may further include a second reformer for steam-reforming again the reformed gas from which carbon dioxide gas has been removed by the carbon dioxide gas removing means. Alternatively, the reformer for steam reforming may enclose the carbon dioxide removing apparatus which uses the carbon dioxide absorbent containing Ba₂TiO₄ as a main component so that carbon dioxide produced by steam reforming is removed by absorption within the reformer.

### CROSS-REFERENCE TO RELATED APPLICATIONS

This is a continuation under 35 U.S.C. §111(a) of PCT/JP2006/308230 filed Apr. 19, 2006, and claims priority of JP2005-185569 filed Jun. 24, 2005, and JP2005-269058 filed Sep. 15, 2005, incorporated by reference.

### BACKGROUND

1. Technical Field

The present disclosure relates to a reforming apparatus for fuel cells for producing hydrogen using a steam reforming method, and more particularly relates to a reforming apparatus for fuel cells including a carbon dioxide removing apparatus for removing carbon dioxide from a reformed gas at a high temperature.

2. Background Art

For producing hydrogen used for fuel cells, a known method is the steam reforming method in which, for example, as shown in FIG. 5, steam reforming is performed at a high temperature to produce hydrogen from a raw material gas and steam which are supplied to a reforming portion (reformer) 52 adapted for steam reforming using heat energy which is generated by burning a fuel gas in a combustion portion 51, and then, the reformed gas is passed through a CO converter 53 to remove carbon monoxide (CO) gas contained in the reformed gas, thereby producing high-purity hydrogen.

In other words, in the reforming portion (reformer) 52, reactions proceed according to the following formulae (1) and (2):
CH₄+H₂O→CO+3H₂ (1)
CO+H₂O→CO₂+H₂ (2)

In the CO converter 53, a reaction proceeds according to the above formula (2).

As described above, the reformed gas contains unreacted hydrocarbon gas, CO and CO₂ which are secondarily produced, as well as hydrogen usable as fuel.

Among these gases, CO poisons electrodes and degrades the battery function when the reformed gas is used for a fuel cell. Therefore, in a phosphoric acid fuel cell (PAFC), the CO concentration in the reformed gas is decreased to 1% or less using a CO converter for effecting a shift reaction from CO to CO₂. Further, in a proton-exchange membrane fuel cell (PEFC), the CO concentration is decreased to 10 ppm or less by a selective oxidation reactor.

In the selective oxidation reactor, a reaction proceeds according to the following formula (3):
2CO+O₂→2CO₂ (3)

When CO₂ remains in the reformed gas, a reaction reverse to the shift reaction from CO to CO₂ takes place to increase the CO concentration in fuel gas.

Therefore, in order to decrease the load of the CO converter and suppress the reverse shift reaction, there has been proposed a method of absorbing carbon dioxide (carbon dioxide gas) from the reformed gas using Li₂ZrO₃ or Li₄ZrO₄ as a carbon dioxide absorbent (refer to Patent Document 1).

However, in this method, even when the absorbent is used, under actual conditions, it is difficult to absorb carbon dioxide gas at a high temperature (e.g., over 700° C.) at which the steam reforming reaction is actually performed.

In a temperature region of 700° C. or less in which carbon dioxide can be absorbed, the shift reaction proceeds accompanying absorption of carbon dioxide, and the CO concentration is decreased. However, it is difficult to decrease the CO concentration to 1% or less in the gas after absorption of carbon dioxide, and use of the proton-exchange membrane fuel cell (PEFC) requires a CO converter provided in front of the selective oxidation reactor.

Another method for producing hydrogen by steam reforming provides for simultaneously performing steam reforming and CO₂ removal at a high temperature (refer to Patent Document 2). This method is aimed at improving the rate of hydrogen conversion in the fuel reformer, decreasing the load of the converter, and suppressing the reverse shift reaction, and includes providing layers respectively filled with a steam reforming catalyst and a carbon dioxide absorbent (CaO) (or a layer of a mixture of a steam reforming catalyst and a carbon dioxide absorbent) in a fuel reformer for producing hydrogen from fuel and steam.

The method using CaO as the carbon dioxide absorbent is capable of absorbing carbon dioxide at a high temperature of 700° C. or higher.

However, in order to absorb carbon dioxide gas at 800° C. using CaO, a necessary carbon dioxide concentration is about 40%, and it is difficult to decrease the carbon dioxide concentration to 10% or less even by absorbing carbon dioxide gas at 750° C. Further, in view of the fact that the carbon dioxide gas concentration after steam reforming is generally about 10%, it is thought to be actually difficult to absorb carbon dioxide gas with CaO under the steam reforming conditions.

In addition, as in the above-mentioned method using Li₂ZrO₃ or Li₄ZrO₄, it is difficult to decrease the CO concentration to 10% or less in the gas after absorption of carbon dioxide even in the temperature region of 700° C. or less in which carbon dioxide can be absorbed, and the use of the proton-exchange membrane fuel cell (PEFC) requires a CO converter provided in front of the selective oxidation reactor.

Patent Document 1: Japanese Unexamined Patent Application Publication No. 2002-255510

Patent Document 2: Japanese Unexamined Patent Application Publication No. 2002-208425

### SUMMARY

The present disclosure will describe a reforming apparatus for fuel cells capable of effectively removing carbon dioxide from a reformed gas at a high temperature which is produced by steam reforming, and capable of producing high-purity hydrogen with a high hydrogen conversion rate.

In order to provide the foregoing advantages, a reforming apparatus for fuel cells which produces hydrogen using a steam reforming method includes a reformer for steam-reforming a raw material to produce hydrogen, and a carbon dioxide removing apparatus for removing carbon dioxide by absorbing carbon dioxide from a reformed gas, which is produced by steam reforming in the reformer, using a carbon dioxide absorbent material containing Ba₂TiO₄ as a main component.

According to another aspect, the reforming apparatus for fuel cells further includes a second reformer for steam-reforming again the reformed gas from which carbon dioxide gas has been removed by the carbon dioxide gas removing apparatus.

According to a further aspect, a reforming apparatus for fuel cells which produces hydrogen using a steam reforming method includes a reformer for steam reforming which contains a carbon dioxide absorbent containing Ba₂TiO₄ as a main component so that carbon dioxide produced by steam reforming is removed by absorption in the reformer.

The reforming apparatus for fuel cells which produces hydrogen by a steam reforming method includes the reformer for steam-reforming a raw material to produce hydrogen, and the carbon dioxide removing apparatus for removing carbon dioxide by absorbing carbon dioxide from the reformed gas, which is produced by steam reforming in the reformer, using a material containing Ba₂TiO₄ as a main component as the carbon dioxide absorbent. Therefore, the carbon dioxide removing apparatus can effectively remove carbon dioxide from the reformed gas and can improve the hydrogen conversion rate to produce high-purity hydrogen.

Namely, in the reformer, reactions proceed according to the following formulae (1) and (2):
CH₄+H₂O→CO+3H₂ (1)
CO+H₂O→CO₂+H₂ (2)

Further, in the carbon dioxide removing apparatus, CO₂ in the reformed gas is removed to allow the equilibrium reaction (2) to proceed rightward, thereby improving the hydrogen conversion rate and decreasing the CO content and thus decreasing the loads of the CO converter and the CO removing device.

Since the equilibrium reaction (1) which is a basic reforming reaction is allowed to proceed rightward by decreasing CO, the hydrogen conversion rate can be further improved.

FIG. 4 is a graph showing a relation between temperature and carbon dioxide gas partial pressure (CO₂ gas partial pressure) (a region in which carbon dioxide can be absorbed on the basis of an experiment) when Ba₂TiO₄ was used as an absorbent. FIG. 4 indicates that when Ba₂TiO₄ is used as an absorbent, the carbon dioxide gas partial pressure is as low as about 0.003 atm at 700° C., about 0.0084 atm at 750° C., and about 0.02 atm at 800° C., and thus the sufficient ability to absorb carbon dioxide at a high temperature is exhibited.

In the reformer, steam reforming is generally performed at a temperature of 700° C. or higher, and the temperature of the reformed gas discharged from the reformer is 700° C. or higher. When CaO or Li containing oxide such as Li₂ZrO₃ or Li₄ZrO₄ is used as the carbon dioxide absorbent as before, it is difficult to efficiently absorb carbon dioxide. However, by using a material containing Ba₂TiO₄ as the carbon dioxide absorbent, carbon dioxide can be efficiently absorbed under a high temperature of 700° C. or higher to produce high-purity hydrogen.

Also, Ba₂TiO₄ can efficiently absorb carbon dioxide at a temperature of 700° C. or less as compared with other materials and thus the CO concentration can be deceased to 1% or less. Even in the use of the proton-exchange membrane fuel cell (PEFC), the CO converter provided in front of the selective oxidation reactor can be omitted.

The carbon dioxide absorbent used in the present invention, containing Ba₂TiO₄ as a main component, can be produced by, for example, burning barium titanate (BaTiO₃) in the presence of barium carbonate (BaCO₃) through a reaction represented by the following formula (4):
BaTiO₃+BaCO₃→Ba₂TiO₄+CO₂↑ (4)

A substance represented by Ba₂TiO₄ absorbs carbon dioxide by a reaction of the formula (5) below under specified conditions to form BaTiO₃.
Ba₂TiO₄+CO₂→BaTiO₃+BaCO₃ (5)

When BaTiO₃ produced by absorption of carbon dioxide is heated to a predetermined temperature or higher (750° C. or higher) under a predetermined pressure condition (reduced pressure of 1000 Pa or less), carbon dioxide is released by a reaction of the formula (6) below to return BaTiO₃ to Ba₂TiO₄.
BaTiO₃+BaCO₃→Ba₂TiO₄+CO₂↑ (6)

Namely, the carbon dioxide absorbent, containing Ba₂TiO₄ as a main component, can absorb and reproduce (release) carbon dioxide using the reactions of the formulae (5) and (6).

The carbon dioxide absorbent used in the present invention, containing Ba₂TiO₄ as a main component, has the ability to absorb carbon dioxide at a high temperature of 500° C. to 900° C. under a pressure in a range of 1.0×10⁴ to 1.0×10⁶ Pa, particularly near atmospheric pressure.

On the other hand, the carbon dioxide absorbent which absorbs carbon dioxide releases carbon dioxide under the conditions including a pressure of 1000 Pa or less and a temperature of 750° C. or more to reproduce Ba₂TiO₄, and thus the absorbent can be repeatedly used for absorbing carbon dioxide. Also, since the volume expansion by carbon dioxide absorption is as low as about 10%, little stress occurs in repeated use, and excellent durability can be realized.

The material containing Ba₂TiO₄ as a main component, which serves as the carbon dioxide absorbent, can also be synthesized from raw materials such as an oxide and a carbonate. Also, the carbon dioxide absorbent can be produced by burning, in the presence of barium carbonate, a material containing a main component which contains Ba and Ti at a molar ratio (X/Y) of about 1:1 and which has a perovskite structure as a main crystal structure. Such a material can be at least one of a green sheet, a green sheet waste material, a green sheet laminate waste material, and a green sheet precursor, which are used in an electronic component manufacturing process.

Green sheet material is produced by forming a slurry containing BaTiO₃ as a main component and a binder into a sheet, and green sheet waste material that becomes surplus after being produced for manufacturing an electronic component can be used as a raw material for producing the carbon dioxide absorbent disclosed herein.

A green sheet waste material is an unnecessary sheet after necessary portions have been taken out from the green sheet and can be preferably used as a raw material for producing the carbon dioxide absorbent.

A green sheet laminate waste material is, for example, a waste material of a green laminate prepared by laminating the green sheets on each of which an electrode material has been printed and then compressing the green sheets. The green sheet laminate waste material can also be used as a raw material for producing the carbon dioxide absorbent.

A green sheet precursor is, for example, a ceramic slurry containing BaTiO₃ and a binder which are dispersed in a dispersing agent, or BaTiO₃ prepared to be dispersed in a dispersing agent. The green sheet precursor can also be used as a raw material for producing the carbon dioxide absorbent when it is not needed for manufacturing an electronic component after being prepared.

The type and structure of the reformer which can be used are not particularly limited, and any one of various structures, such as a structure including a Ni- or Ru-based catalyst carried as a steam reforming catalyst on a surface of an alumina substrate or the like, can be used.

The structure of the carbon dioxide removing apparatus using as the carbon dioxide absorbent the material containing Ba₂TiO₄ as a main component is not particularly limited. For example, any one of various structures, such as a structure including a reactor filled with the carbon dioxide absorbent or a reactor containing the carbon dioxide absorbent held on a carrier, can be used.

The reforming apparatus for fuel cells may further include an additional reformer for steam-reforming again the reformed gas from which carbon dioxide has been removed by the carbon dioxide removing apparatus. In this case, steam reforming is carried out again after carbon dioxide gas has been removed, and the reactions of the formulae (1) and (2) can be allowed to further proceed in the reformer, thereby further improving the hydrogen conversion rate.
CH₄+H₂O→CO+3H₂ (1)
CO+H₂O→CO₂+H₂ (2)

Further, in another reforming apparatus for fuel cells which produces hydrogen using a steam reforming method, a reformer for steam reforming is filled with a carbon dioxide absorbent containing Ba₂TiO₄ as a main component so that the carbon dioxide produced by steam reforming is removed by absorption by the carbon dioxide absorbent filling the reformer. Therefore, the carbon dioxide which inhibits the formation of hydrogen by steam reforming can be rapidly removed in the reformer, and the reactions of the above formulae (1) and (2) can be allowed to proceed in the reformer, thereby further improving the hydrogen conversion rate.

An advantage is that carbon dioxide removing equipment need not be separately provided, and thus the equipment cost and space can be saved.

Other features and advantages of the disclosed apparatus will become apparent from the following description of embodiments thereof which refers to the accompanying drawings.

### DESCRIPTION OF THE DRAWINGS

FIG. 1 is a drawing showing the constitution of a reforming apparatus for fuel cells according to an embodiment (Examples 1 to 4).

FIG. 2 is a drawing showing the constitution of a reforming apparatus for fuel cells according to another embodiment (Example 5).

FIG. 3 is a drawing showing the constitution of a reforming apparatus for fuel cells according to a further embodiment (Examples 6 and 7).

FIG. 4 is a graph showing a relation (a region in which carbon dioxide can be absorbed on the basis of an experiment) between temperature and carbon dioxide gas partial pressure (CO₂ partial pressure) when Ba₂TiO₄ is used as an absorbent.

FIG. 5 is a drawing showing a conventional reforming apparatus for fuel cells.

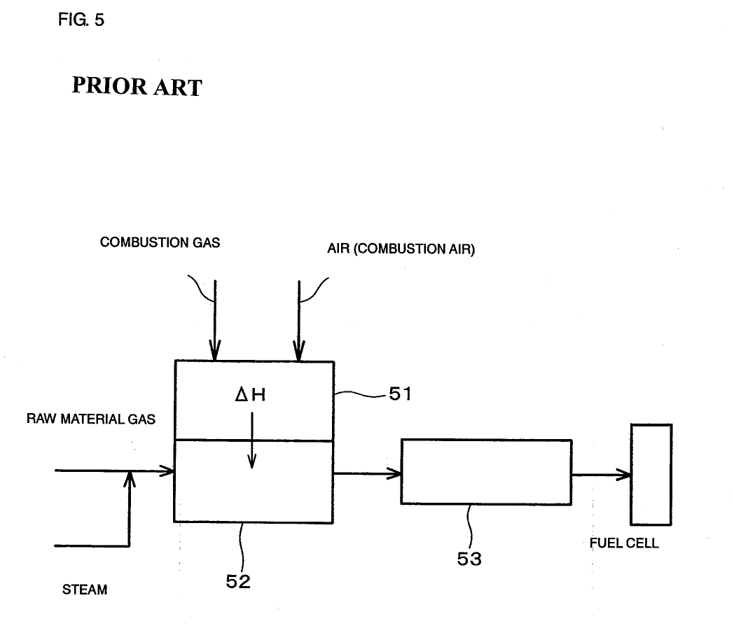

### REFERENCE NUMERALS

1 reformer
2 carbon dioxide removing apparatus (carbon dioxide absorber)
3 CO converter
11 carbon dioxide absorbent
12 reactor
21a first reformer
21b second reformer
22a first carbon dioxide removing apparatus
22b second carbon dioxide removing apparatus
23 CO converter
30 reactor
31 reformer
32 carbon dioxide removing apparatus (carbon dioxide absorber)
33 CO converter 34 steam reforming catalyst

### DETAILED DESCRIPTION

### Examples

The characteristics of the disclosed apparatus will be described in further detail with reference to examples.

Description will be made of, as an example, a hydrogen producing apparatus (reforming apparatus for fuel cells) for reforming hydrocarbon (CH₄) using a steam reformer to produce hydrogen.

### Example 1

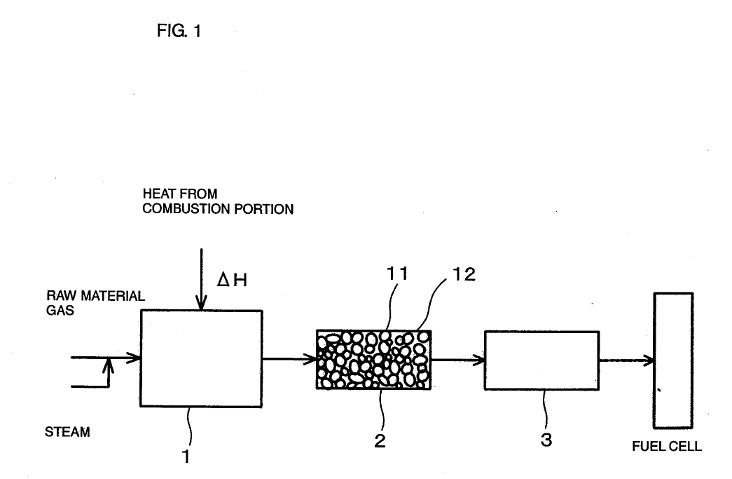

FIG. 1 is a drawing showing the constitution of a hydrogen producing apparatus for fuel cells (reforming apparatus for fuel cells) according to an embodiment of the present invention.

As shown in FIG. 1, the reforming apparatus for fuel cells includes a reformer 1 for steam-reforming a raw material gas (in this example, CH₄) to produce hydrogen, a carbon dioxide removing apparatus 2 for absorbing and removing carbon dioxide gas generated from the reformed gas at a high temperature, which is produced by reforming in the reformer 1, and a CO converter 3 for removing carbon monoxide (CO) in the reformed gas after removal of the carbon dioxide.

The reformer 1 uses a Ni-based catalyst as a reforming catalyst and is adapted for steam reforming using heat generated by burning a combustion gas in a combustion portion. Since a sulfur compound is harmful to the reforming catalyst, a raw material gas is introduced into the reformer 1 after being passed through a desulfurizer for removing a sulfur compound (this applies to Examples 2 to 7 described below).

The constitution of the reformer 1 is not particularly limited, and a reformer using a Ru-based catalyst other than the Ni-based catalyst as the steam reforming catalyst can be used.

In the reforming apparatus for fuel cells of this example, a carbon dioxide absorber including a reactor 12 filled with a carbon dioxide absorbent 11 which contains Ba₂TiO₄ as a main component is used as the carbon dioxide removing apparatus 2, and the carbon dioxide removing apparatus (carbon dioxide absorber) 2 is disposed at the outlet of the reformer 1.

The reforming apparatus for fuel cells which had the above-described constitution was used for steam reforming in the reformer 1 in which the internal temperature was set to 750° C., and the reformed gas discharged from the reformer 1 was introduced into the carbon dioxide removing apparatus 2 for removing carbon dioxide by absorption. The temperature of the reformed gas produced by steam reforming under the above conditions at the inlet of the carbon dioxide removing apparatus (carbon dioxide absorber) 2 was 732° C.

Also, the composition (concentrations of H₂, CO, CO₂, and hydrocarbon (CH₄)) of the reformed gas was measured before (immediately after being discharged from the reformer 1) and after passing through the carbon dioxide removing apparatus (carbon dioxide absorber) 2.

The measured compositions of the reformed gas are shown below.

(1) Composition of the reformed gas before passing through the carbon dioxide removing apparatus

H₂: about 71 vol %

CO: 13 vol %

CO₂: 10 vol %

Hydrocarbon (CH₄): 6 vol %

(2) Composition of the reformed gas after passing through the carbon dioxide removing apparatus

H₂: about 93 vol %

CO: 1.2 vol %

CO₂: 0.6 vol %

Hydrocarbon (CH₄): 5 vol %

Each of the gas concentrations was determined by sampling the reformed gas during operation and measuring a sample with gas chromatography.

### Example 2

The same raw material gas (hydrocarbon (CH₄)) as in Example 1 was steam-reformed under the same conditions as in Example 1 except that the internal temperature of the reformer 1 was set to 720° C., and then the reformed gas discharged from the reformer 1 was supplied to the carbon dioxide removing apparatus 2 for removing carbon dioxide by absorption. The temperature of the reformed gas at the inlet of the carbon dioxide removing means (carbon dioxide absorber) 2 was 700° C.

Also, the composition (concentrations of H₂, CO, CO₂, and hydrocarbon (CH₄)) of the reformed gas was measured after passing through the carbon dioxide removing apparatus (carbon dioxide absorber) 2.

The results were as following.

(1) Composition of the reformed gas after passing through the carbon dioxide removing apparatus
H₂: about 93 vol %
CO: 0.4 vol %
CO₂: 0.2 vol %
Hydrocarbon (CH₄): 6 vol %

### Example 3

The same raw material gas (hydrocarbon (CH₄)) as in Example 1 was steam-reformed under the same conditions as in Example 1 except that the internal temperature of the reformer 1 was set to 700° C., and then the reformed gas discharged from the reformer 1 was supplied to the carbon dioxide removing apparatus 2 for removing carbon dioxide by absorption. The temperature of the reformed gas at the inlet of the carbon dioxide removing apparatus (carbon dioxide absorber) 2 was 661° C.

Also, the composition (concentrations of H₂, CO, CO₂, and hydrocarbon (CH₄)) of the reformed gas was measured after passing through the carbon dioxide removing apparatus (carbon dioxide absorber) 2.

The results were as following.

(1) Composition of the reformed gas before passing through the carbon dioxide removing apparatus
H₂: about 67 vol %
CO: 13 vol %
CO₂: 11 vol %
Hydrocarbon (CH₄): 9 vol %

(2) Composition of the reformed gas after passing through the carbon dioxide removing apparatus
H₂: about 91 vol %
CO: 0.1 vol %
CO₂: 0.1 vol % or less
Hydrocarbon (CH₄): 8 vol %

### Example 4

The same raw material gas (hydrocarbon (CH₄)) as in Example 1 was steam-reformed under the same conditions as in Example 1. The reformed gas was cooled during a distance provided between the reformer 1 and the carbon dioxide removing apparatus 2 and then supplied to the carbon dioxide removing apparatus 2 for removing carbon dioxide by absorption. The temperature of the reformed gas at the inlet of the carbon dioxide removing apparatus (carbon dioxide absorber) 2 was 634° C. due to the cooling effect.

Also, the composition (concentrations of H₂, CO, CO₂, and hydrocarbon (CH₄)) of the reformed gas was measured after passing through the carbon dioxide removing apparatus (carbon dioxide absorber) 2.

The results were as following.

(1) Composition of the reformed gas before passing through the carbon dioxide removing apparatus
H₂: about 71 vol %
CO: 13 vol %
CO₂: 10 vol %
Hydrocarbon (CH₄): 6 vol %

(2) Composition of the reformed gas after passing through the carbon dioxide removing apparatus
H₂: about 95 vol %
CO: 0.1 vol % or less
CO₂: 0.1 vol % or less
Hydrocarbon (CH₄): 5 vol %

### Example 5

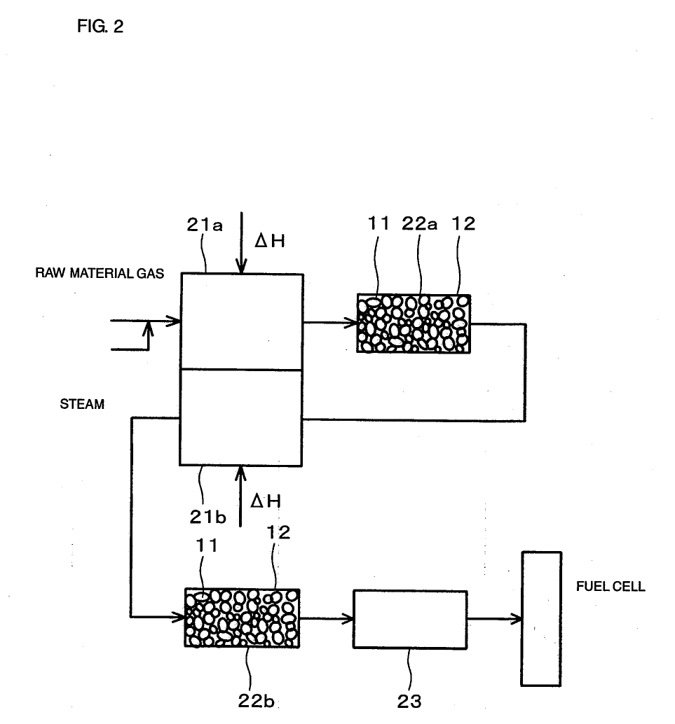

FIG. 2 is a drawing showing the constitution of a hydrogen producing apparatus for fuel cells (a reforming apparatus for fuel cells) according to another embodiment.

As shown in FIG. 2, the reforming apparatus for fuel cells includes a first reformer 21a for steam-reforming a raw material gas (hydrocarbon (CH₄)) to produce hydrogen, first carbon dioxide removing apparatus 22a for absorbing and removing carbon dioxide generated from the reformed gas which is produced by reforming in the first reformer 21a, a second reformer 21b for further steam-reforming the reformed gas after carbon dioxide gas is removed by the first carbon dioxide removing apparatus 22a, second carbon dioxide removing means 22a for absorbing and removing carbon dioxide produced in the second steam reforming step from the reformed gas which is produced by reforming in the second reformer 21b, and a CO converter 23 for removing carbon monoxide (CO) in the reformed gas after removal of the carbon dioxide in the second carbon dioxide removing apparatus 22b.

As in Example 1, each the first and second reformers 21a and 21b uses a Ni-based catalyst as a reforming catalyst.

Like in Example 1, as each of the first and second carbon dioxide removing apparatus 22a and 22b, a carbon dioxide absorber including a reactor 12 filled with a carbon dioxide absorbent 11 which contains Ba₂TiO₄ as a main component is used.

The reforming apparatus for fuel cells was used for steam reforming in the first and second reformers 21a and 21b in each of which the internal temperature was set to 750° C., and the reformed gas discharged from the first reformer 21a was supplied to the first carbon dioxide removing apparatus 22a for removing carbon dioxide by absorption and further steam-reformed again in the second reformer 21b. The reformed gas discharged from the second reformer 21b was supplied to the second carbon dioxide removing apparatus 22b for removing, by absorption, carbon dioxide produced in the second steam reforming step. The temperature of the reformed gas at the inlet of the first carbon dioxide removing apparatus (carbon dioxide absorber) 22a was 742° C.

Also, the composition (concentrations of H₂, CO, CO₂, and hydrocarbon (CH₄)) of the reformed gas was measured after passing through the first carbon dioxide removing apparatus 22a and after passing through the second reformer 21b and the second carbon dioxide removing apparatus 22b.

The results were as shown below.

(1) Composition of the reformed gas after passing through the first carbon dioxide removing apparatus
H₂: about 93 vol %
CO: 1.2 vol %
CO₂: 0.6 vol %
Hydrocarbon (CH₄): 5 vol %

(2) Composition of the reformed gas after passing through the second reformer and the second carbon dioxide removing apparatus
H₂: about 97 vol %
CO: 1.2 vol %
CO₂: 0.6 vol %
Hydrocarbon (CH₄): 1.5 vol %

### Example 6

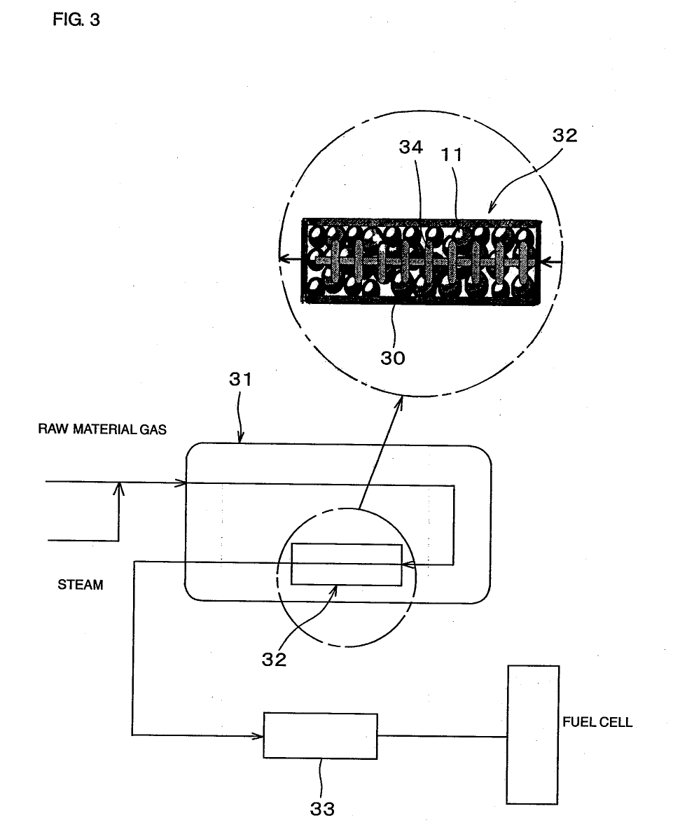

FIG. 3 is a drawing showing the constitution of a hydrogen producing apparatus for fuel cells (reforming apparatus for fuel cells) according to a further embodiment.

As shown in FIG. 3, the reforming apparatus for fuel cells includes a reformer 31 for steam-reforming a raw material gas (hydrocarbon (CH₄)) to produce hydrogen, carbon dioxide removing apparatus (carbon dioxide absorber) 32 disposed in the reformer 31, and a CO converter 33 for removing carbon monoxide (CO) in the reformed gas which is produced by reforming in the reformer 31. In Example 6, a carbon dioxide absorber including a reactor 30 filled with a carbon dioxide absorbent 11 which contains Ba₂TiO₄ as a main component is used as the carbon dioxide removing apparatus 32.

However, in this example, as schematically shown in FIG. 3, the reactor 30 contains a steam reforming catalyst (e.g., a Ni catalyst) 34 as well as the carbon dioxide absorbent 11 containing Ba₂TiO₄ as a main component.

The reforming apparatus for fuel cells was used for steam reforming in the reformer 31 in which the internal temperature was set to 750° C.

Also, the composition (concentrations of H₂, CO, CO₂, and hydrocarbon (CH₄)) of the reformed gas discharged from the reformer 31 was measured.

The results were as shown below.

(1) Composition of the reformed gas discharged from the reformer
H₂: about 98 vol %
CO: 1.2 vol %
CO₂: 0.6 vol %
Hydrocarbon (CH₄): 0.2 vol %

The reforming apparatus for fuel cells of Example 6 produces high-purity hydrogen as described above. This is possibly because the carbon dioxide produced accompanying the production of hydrogen by steam reforming in the reformer 31 is absorbed and removed by the carbon dioxide absorbent 11 present near the steam reforming catalyst 34, thereby allowing a steam reforming reaction to efficiently proceed.

### Example 7

The same raw material gas (hydrocarbon (CH₄)) as in Example 6 was steam-reformed under the same conditions as in Example 6 except that the internal temperature of the reformer 31 was set to 700° C. Also, the composition (concentrations of H₂, CO, CO₂, and hydrocarbon (CH₄)) of the reformed gas discharged from the reformer 31 was measured.

The results were as following:

(1) Composition of the reformed gas discharged from the reformer
H₂: about 99 vol %
CO: 0.4 vol %
CO₂: 0.2 vol %
Hydrocarbon (CH₄): 0.5 vol %

### Comparative Example 1

Steam reforming was performed in a reformer in which the internal temperature was set to 750° C. using a hydrogen producing apparatus not provided with carbon dioxide removing means (the same as the reforming apparatus for fuel cells shown in FIG. 1 except that the carbon dioxide removing means 2 is not provided).

Also, the composition (concentrations of H₂, CO, CO₂, and hydrocarbon (CH₄)) of the reformed gas discharged from the reformer was measured.

The results were as follows:

(1) Composition of the reformed gas discharged from the reformer
H₂: about 71 vol %
CO: 13 vol %
CO₂: 10 vol %
Hydrocarbon (CH₄): 6 vol %

The composition of the reformed gas was the same as that of the reformed gas immediately after being discharged from the reformer 1 in Example 1 (i.e., the reformed gas before passing through the carbon dioxide removing apparatus (carbon dioxide absorber) 2).

### Comparative Example 2

The same raw material gas (hydrocarbon (CH₄)) as in Comparative Example 1 was steam-reformed under the same conditions as in Comparative Example 1 except that the internal temperature of the reformer 1 was set to 700° C. Also, the composition (concentrations of H₂, CO, CO₂, and hydrocarbon (CH₄)) of the reformed gas discharged from the reformer was measured.

The results were as follows:

(1) Composition of the reformed gas discharged from the reformer
H₂: about 67 vol %
CO: 13 vol %
CO₂: 11 vol %
Hydrocarbon (CH₄): 9 vol %

The composition of the reformed gas was the same as that of the reformed gas immediately after being discharged from the reformer 1 in Example 3 (i.e., the reformed gas before passing through the carbon dioxide removing apparatus (carbon dioxide absorber) 2).

### Comparative Example 3

Steam reforming was performed in a reformer in which the internal temperature was set to 750° C. using a reforming apparatus for fuel cells having the same constitution as that shown in FIG. 1 except that a carbon dioxide absorber including a reactor filled with CaO (carbon dioxide absorbent) was used as the carbon dioxide removing apparatus 2 of the reforming apparatus for fuel cells of Example 1. Then, the reformed gas discharged from the reformer was supplied to the carbon dioxide removing apparatus for absorbing and removing carbon dioxide. The temperature of the reformed gas at the inlet of the carbon dioxide removing apparatus (carbon dioxide absorber) was 728° C.

Also, the composition (concentrations of H₂, CO, CO₂, and hydrocarbon (CH₄)) of the reformed gas was measured before (immediately after being discharged from the reformer) and after passing through the carbon dioxide removing apparatus (carbon dioxide absorber).

The results were as follows:

(1) Composition of the reformed gas before passing through the carbon dioxide removing apparatus
H₂: about 71 vol %
CO: 13 vol %
CO₂: 10 vol %
Hydrocarbon (CH₄): 6 vol %

(2) Composition of the reformed gas after passing through the carbon dioxide removing apparatus
H₂: about 73 vol %
CO: 12 vol %
CO₂: 10 vol %
Hydrocarbon (CH₄): 5 vol %

### Comparative Example 4

The same raw material gas (hydrocarbon (CH₄)) as in Comparative Example 3 was steam-reformed under the same conditions as in Comparative Example 3 except that the internal temperature of the reformer 1 was set to 700° C. Then, the reformed gas discharged from the reformer 1 was supplied to the carbon dioxide removing apparatus 2 for removing carbon dioxide by absorption. The temperature of the reformed gas at the inlet of the carbon dioxide removing apparatus (carbon dioxide absorber) 2 was 640° C.

Also, the composition (concentrations of H₂, CO, CO₂, and hydrocarbon (CH₄)) of the reformed gas was measured after passing through the carbon dioxide removing apparatus (carbon dioxide absorber) 2.

The results were as follows:

(1) Composition of the reformed gas before passing through the carbon dioxide removing apparatus
H₂: about 67 vol %
CO: 13 vol %
CO₂: 11 vol %
Hydrocarbon (CH₄): 9 vol %

(2) Composition of the reformed gas after passing through the carbon dioxide removing apparatus
H₂: about 89 vol %
CO: 1.8 vol %
CO₂: 1.5 vol %
Hydrocarbon (CH₄): 8 vol %

With respect to Comparative Examples 3, the carbon dioxide concentration in the reformed gas supplied to the carbon dioxide removing means is 10 vol %. Therefore, in Comparative Example 3 using CaO as the carbon dioxide absorbent, carbon dioxide cannot be efficiently removed from the reformed gas.

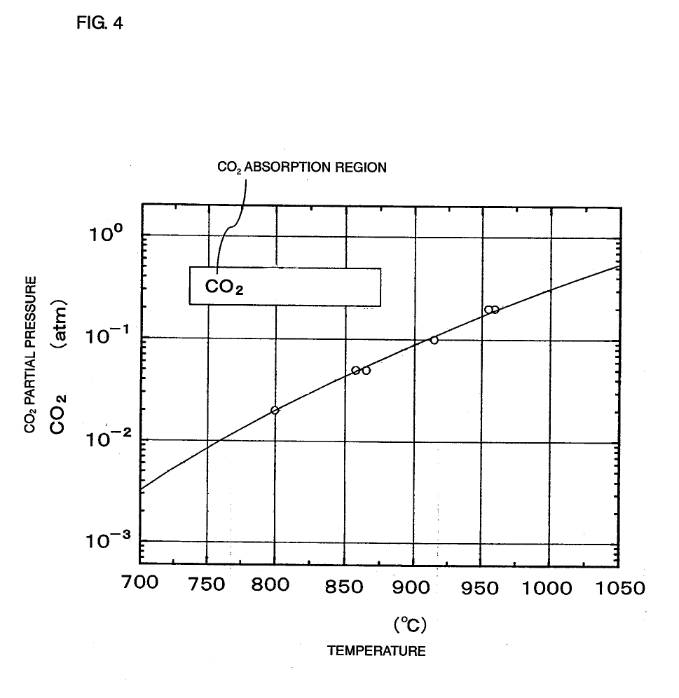

When Ba₂TiO₄ is used as the absorbent, the relation between temperature and carbon dioxide partial pressure (CO₂ partial pressure) is as shown in FIG. 4. Namely, the carbon dioxide gas partial pressure is about 0.003 atm at 700° C., about 0.0084 atm at 750° C., and as low as about 0.02 atm at 800° C., and thus the sufficient ability to absorb carbon dioxide at a high temperature is exhibited. However, it is supposed from the results of Comparative Examples 3 that when CaO is used, the carbon dioxide partial pressure at 750° C. is significantly high and about ten times as high as that in the use of Ba₂TiO₄ as the absorbent.

On the other hand, in Comparative Example 4, the carbon dioxide gas partial pressure is decreased by a decrease in temperature, and the effect of carbon dioxide absorption is observed. However, the carbon dioxide concentration and CO concentration are higher than those in the use of Ba₂TiO₄ as the absorbent. Therefore, use for the proton-exchange membrane fuel cell (PEFC) requires a CO converter disposed in front of the selective oxidation reactor, for performing CO conversion.

Evaluation

The compositions of the reformed gases after passing through the carbon dioxide removing means in Examples 1 to 7 and Comparative Examples 1 to 4 are summarized in Table 1.

TABLE 1

| | Internal | Inlet temperature of | | | | |
|---|---|---|---|---|---|---|
| | temperature | carbon dioxide | Concentration of reformed gas | | | |
| | of reformer | removing apparatus | (vol %) | | | |
| | (° C.) | (° C.) | H₂ | CO | CO₂ | CH₄ |
| Example 1 | 750 | 732 | About 93 | 1.2 | 0.6 | 5 |
| Example 2 | 720 | 700 | About 93 | 0.4 | 0.2 | 6 |
| Example 3 | 700 | 661 | About 91 | 0.1 | <0.1 | 8 |
| Example 4 | 750 | 634 | About 95 | <0.1 | <0.1 | 5 |
| Example 5 | 750 | 742 | About 97 | 1.2 | 0.6 | 1.5 |
| Example 6 | 750 | — | About 98 | 1.2 | 0.6 | 0.2 |
| Example 7 | 700 | — | About 99 | 0.4 | 0.2 | 0.5 |
| Comparative | 750 | — | About 71 | 13 | 10 | 6 |
| Example 1 | | | | | | |
| Comparative | 700 | — | About 67 | 13 | 11 | 9 |
| Example 2 | | | | | | |
| Comparative | 750 | 728 | About 73 | 12 | 10 | 5 |
| Example 3 | | | | | | |
| Comparative | 700 | 640 | About 89 | 1.8 | 1.5 | 8 |
| Example 4 | | | | | | |

However, in Table 1, the gas composition in Example 5 is the composition of the reformed gas after passing through the second carbon dioxide removing apparatus, and the gas composition in each of Examples 6 and 7 is the composition of the reformed gas at the outlet of the reformer 31 containing the carbon dioxide removing apparatus (carbon dioxide absorber) 32. The gas composition of each of Comparative Examples 1 and 2 is the composition of the reformed gas (reformed gas before removal of carbon dioxide) at the outlet of the reformer.

Table 1 indicates that in Examples 1 to 4 of the present invention in which the carbon dioxide removing apparatus using Ba₂TiO₄ as the CO₂ absorbent is disposed at the outlet of the reformer, the hydrogen conversion rate is significantly improved. This is because when CO₂ is removed by the carbon dioxide removing apparatus, the equilibrium reaction of the formula (2) below proceeds rightward in the carbon dioxide removing apparatus using the CO₂ absorbent. Also, when the equilibrium reaction of the formula (2) proceeds rightward, the CO content is decreased, thereby decreasing the loads of the CO converter and the CO removing device. Further, when the CO content is decreased, the equilibrium reaction of the formula (1) which is a basic reforming reaction also proceeds rightward, thereby further improving the hydrogen conversion rate. The effect of decreasing the CO concentration can be obtained by removing CO₂.
CH₄+H₂O→CO+3H₂ (1)
CO+H₂O→CO₂+H₂ (2)

It is also found that as in Examples 2 and 3, the contents of CO₂ and CO can be decreased by decreasing the temperature of the reformer although the amount of remaining CH₄ (hydrocarbon) is decreased. In this case, the CO concentration is decreased to 1% or less at which the CO converter is not required, and thus the CO converter can be made unnecessary for the reforming apparatus for fuel cells of the present invention.

On the other hand, when the temperature of the reformer is decreased, the amount of remaining unreacted methane tends to be increased. However, as in Example 4, an increase in hydrogen concentration and a decrease in CO concentration can be achieved by absorbing carbon dioxide at 650° C. or less after reforming reaction at 750° C.

Further, like in Example 5, when the reformed gas is reformed again, steam reforming is performed again after the CO and CO₂ concentrations are decreased, and thus the equilibrium reaction of the formula (1) proceeds rightward to decrease unreacted CH₄, thereby improving the hydrogen conversion rate.

In Examples 6 and 7 in which the reformer provided with the steam reforming catalyst contains the carbon dioxide absorbent, the hydrogen conversion rate is increased. This is because the carbon dioxide produced accompanying the formation of hydrogen by steam reforming in the reformer is absorbed and removed by the carbon dioxide absorbent present near the steam reforming catalyst, thereby causing the equilibrium reactions of the formulae (1) and (2) to proceed rightward.

As described above, it is confirmed that in each of the examples using as the carbon dioxide absorbent the material containing Ba₂TiO₄ as a main component, carbon dioxide can be efficiently removed as compared with Comparative Examples 3 and 4 using CaO as the carbon dioxide absorbent, and high-purity hydrogen can be obtained.

Also, the CO concentration in the gas at a temperature of 700° C. or less after absorption of carbon dioxide is 1% or less, and even in use with a reforming apparatus for fuel cells (PEFC), it is unnecessary to dispose the CO converter in front of the selective oxidation reactor.

Although, in each of the examples, production of hydrogen using hydrocarbon (CH₄) as a raw material (raw material gas) is described as an example, the present invention can be widely applied to cases using natural gas containing hydrocarbon as a main component, alcohol, and gases other than CH₄ as the raw material gas.

With respect to other features, the present invention is not limited to the above examples, various applications and modifications can be made to steam reforming conditions in the reformer, specified constitutions and operation conditions of the carbon dioxide removing apparatus, and the like within the scope of the present invention.

As disclosed herein, a material containing Ba₂TiO₄ as a main component is used as the carbon dioxide absorbent, and thus carbon dioxide can be efficiently removed from the reformed gas at a high temperature which is produced by a steam reforming method, thereby improving the hydrogen conversion rate and producing high-purity hydrogen.

Therefore, the present invention can be widely used for a reforming apparatus for fuel cells which produces hydrogen by the steam reforming method.

When carbon dioxide is absorbed at a temperature of 700° C. or less, the CO concentration in gas after absorption of carbon dioxide can be decreased to 1% or less, and a system not requiring a CO converter can be provided for a reforming apparatus for fuel cells suitable for a phosphoric acid fuel cell (PAFC) and a reforming apparatus for fuel cells suitable for a proton-exchange membrane fuel cell (PEFC).

Although particular embodiments have been described, many other variations and modifications and other uses will become apparent to those skilled in the art. Therefore, the present invention is not limited by the specific disclosure herein.

What is claimed is:

1. A reforming apparatus for fuel cells which produces hydrogen by steam-reforming, the apparatus comprising:
a reformer for steam-reforming a raw material to produce hydrogen gas; and
carbon dioxide removing apparatus for receiving reformed gas from the reformer, and removing carbon dioxide by absorbing carbon dioxide from the reformed gas, using a material containing Ba₂TiO₄ as a main component as a carbon dioxide absorbent.

2. The reforming apparatus for fuel cells according to claim 1, wherein said carbon dioxide removing apparatus includes a reactor containing said material containing Ba₂TiO₄.

3. The reforming apparatus for fuel cells according to claim 1, wherein the temperature of said reformed gas is at least 700° C.

4. The reforming apparatus for fuel cells according to claim 3, wherein the temperature of said reformed gas is at least 750° C.

5. The reforming apparatus for fuel cells according to claim 1, further comprising a second reformer for receiving and steam-reforming again the reformed gas from which carbon dioxide gas has been removed by the carbon dioxide removing apparatus.

6. The reforming apparatus for fuel cells according to claim 5, wherein said carbon dioxide removing apparatus includes a reactor containing said material containing Ba₂TiO₄.

7. A reforming apparatus for fuel cells according to claim 1, wherein said carbon dioxide removing apparatus is enclosed within the reformer so that carbon dioxide produced by steam reforming is removed by absorption within the reformer.

8. The reforming apparatus for fuel cells according to claim 7, wherein said carbon dioxide removing apparatus includes a reactor containing said material containing Ba₂TiO₄.

9. The reforming apparatus for fuel cells according to claim 7, wherein the temperature of said reformed gas is at least 700° C.

10. The reforming apparatus for fuel cells according to claim 9, wherein the temperature of said reformed gas is at least 750° C.

11. A reforming method for producing hydrogen for fuel cells by steam-reforming, the method comprising the steps of:
steam-reforming a raw material in a reformer to produce hydrogen gas; and
removing carbon dioxide from the reformed gas from the reformer, by absorbing carbon dioxide from the reformed gas using a material containing Ba₂TiO₄ as a main component as a carbon dioxide absorbent.

12. The reforming apparatus for fuel cells according to claim 11, wherein the temperature of said reformed gas is at least 700° C.

13. The reforming apparatus for fuel cells according to claim 12, wherein the temperature of said reformed gas is at least 750° C.

14. The reforming method according to claim 11, further comprising the step of a second reformer receiving and steam-reforming again the reformed gas from which carbon dioxide gas has been removed by said carbon dioxide removing apparatus.

15. A reforming method according to claim 11, further comprising the step of enclosing the carbon dioxide removing apparatus within the reformer so that carbon dioxide produced by steam reforming is removed by absorption within the reformer.

16. The reforming method according to claim 15, wherein the temperature of said reformed gas is at least 700° C.

17. The reforming method according to claim 16, wherein the temperature of said reformed gas is at least 750° C.
